(19) United States
(12) Patent Application Publication
(10) Pub. No.: US 2025/0108614 A1
(43) Pub. Date: Apr. 3, 2025

(54) LIQUID EJECTION HEAD AND LIQUID EJECTION APPARATUS

(71) Applicant: SEIKO EPSON CORPORATION, Tokyo (JP)

(72) Inventors: Fumiya TAKINO, SHIOJIRI-SHI (JP); Shun KATSUIE, MATSUMOTO-SHI (JP)

(21) Appl. No.: 18/899,023

(22) Filed: Sep. 27, 2024

(30) Foreign Application Priority Data
Sep. 29, 2023 (JP) 2023-169933

(51) Int. Cl. B41J 2/14

(52) U.S. Cl. CPC B41J 2/14

(57) ABSTRACT

A liquid ejection head includes: five or more head chips disposed along a first-direction in a staggered manner, and a support member supporting the head chips, the head chips are disposed to have overlapping regions where a part of a nozzle forming region of one head chip of adjacent head chips and a part of a nozzle forming region of other head chip overlap when viewed in a second-direction that is perpendicular to the first direction, the overlapping regions include a first-overlapping region, and a second-overlapping region that is farther away from a center position of a total nozzle forming region with respect to the first-direction than the first-overlapping region, the total nozzle forming region including all the nozzle forming regions of the head chips, and the second-overlapping region is larger than the first-overlapping region with respect to the first-direction.

The present application is based on, and claims priority from JP Application Serial Number 2023-169933, filed Sep. 29, 2023, the disclosure of which is hereby incorporated by reference herein in its entirety.

### BACKGROUND

### 1. Technical Field

The present disclosure relates to a liquid ejection head and a liquid ejection apparatus.

### 2. Related Art There has been proposed a liquid ejection apparatus

including a liquid ejection head that ejects liquid such as ink, or the like, to a medium such as a print sheet.

A liquid ejection head described in JP-A-2016-489 includes a plurality of head units (corresponding to head chips) disposed in a staggered manner, a fixing plate, and a case member (corresponding to a frame portion). The plurality of head units is housed and supported in a space formed by the fixing plate and the frame portion.

In a liquid ejection head described in JP-A-2016-489, adjacent head chips of a plurality of head chips have a region where the adjacent head chips overlap with each other. In JP-A-2016-489, the plurality of head chips is disposed in a staggered manner, and there is five or more overlapping regions.

If five or more head chips are disposed in a staggered manner in a predetermined direction, as described in the literature, the liquid ejection head becomes elongated in the predetermined direction. In addition, head chips disposed on a center side with respect to the predetermined direction being adjacent to four head chips, temperature of the center side of the liquid ejection head is higher than a size of end sides due to heat generation of the five or more head chips. As a result, a temperature difference occurs in the liquid ejection head, and there is a risk that members constituting the liquid ejection head may be affected by warping.

### SUMMARY

A liquid ejection head according to one aspect of the present disclosure includes a plurality of, five or more, head chips disposed along a first direction in a staggered manner, and a support member supporting the plurality of head chips, the plurality of head chips is disposed to have overlapping regions where a part of a nozzle forming region of one head chip of adjacent head chips and a part of a nozzle forming region of other head chip overlap when viewed in a second direction that is perpendicular to the first direction, the plurality of overlapping regions includes a first overlapping region, and a second overlapping region that is farther away from a center position of a total nozzle forming region with respect to the first direction than the first overlapping region, the total nozzle forming region including all the nozzle forming regions of the plurality of head chips, and the second overlapping region is larger than the first overlapping region with respect to the first direction.

A liquid ejection apparatus according to another aspect of the present disclosure includes a liquid ejection head that ejects liquid to a medium, and a transport unit that transports the medium.

### BRIEF DESCRIPTION OF THE DRAWINGS

FIG. 1 is a schematic diagram illustrating a configuration example of a liquid ejection apparatus according to a first embodiment.

FIG. 2 is an exploded perspective view of the liquid ejection head illustrated in FIG. 1.

FIG. 3 is a cross-sectional view taken along a line III-III in FIG. 2.

FIG. 4 is a top view of a liquid ejection head of the first embodiment.

FIG. 5 is a cross-sectional view taken along a line V-V in FIG. 4.

FIG. 6 is a schematic diagram of a lower surface of the liquid ejection head of the first embodiment.

FIG. 7 is a bottom view of the liquid ejection head of the first embodiment.

FIG. 8 is a bottom view of a liquid ejection head of a comparative example.

FIG. 9 is a diagram illustrating the number of overlapping nozzles in the first overlapping region where ink droplets are ejected.

FIG. 10 is a diagram illustrating a number of overlapping nozzles in the second overlapping region where ink droplets are ejected.

FIG. 11 is a bottom view of a liquid ejection head of a first modification example.

FIG. 12 is a bottom view of a liquid ejection head of a second modification example.

### DESCRIPTION OF EMBODIMENTS

Hereinafter, a description will be given of preferable embodiments according to the present disclosure, with respect to the accompanying drawings. Note that the dimensions and scale of each part in the drawings may differ from the actual dimensions, and some parts are schematically illustrated to facilitate understanding. In addition, the scope of the present disclosure is not limited to these forms unless otherwise specified in the following description to the effect that the present disclosure is limited.

In addition, the following description will be given appropriately using an X-axis, a Y-axis, and a Z-axis that are mutually intersecting. In addition, a direction along the X-axis is referred to as an X1 direction, and a direction opposite to the X1 direction is referred to as an X2 direction. Similarly, directions that are opposite to each other along the Y-axis are referred to as a Y1 direction and a Y2 direction. Similarly, directions that are opposite to each other along the Z-axis are referred to as a Z1 direction and a Z2 direction. The Y1 direction and the Y2 direction are examples of the “first direction”. The X1 direction and the X2 direction are examples of the “second direction”. In the following, viewing in the Z1 direction and the Z2 direction is referred to as a “planar view”.

Typically, the Z-axis is a perpendicular axis, and the Z1 direction corresponds to a downward direction in the perpendicular direction. However, the Z-axis does not have to be a perpendicular axis. In addition, the X-axis, the Y-axis, and the Z-axis are typically perpendicular to each other, but are not limited to this, and may intersect at an angle ranging from 80° to 100°, for example.

### 1. First Embodiment

### 1-1. Schematic Configuration of the Liquid Ejection Apparatus 100

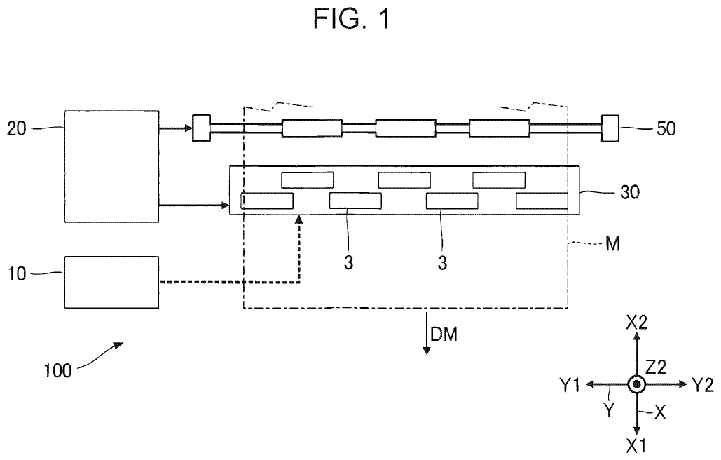

FIG. 1 is a schematic diagram illustrating a configuration example of a liquid ejection apparatus 100 according to a first embodiment. The liquid ejection apparatus 100 is an ink jet type printer that ejects ink, which is an example of liquid, as droplets onto a medium M. The medium M is typically a print sheet. Note that the medium M is not limited to a print sheet, and may be a print target of any material, such as a resin film or a cloth.

As illustrated in FIG. 1, the liquid ejection apparatus 100 includes a liquid container 10, a control unit 20, a transport unit 50, and a liquid ejection head 30.

The liquid container 10 is a container for storing ink. Examples of specific aspects of the liquid container 10 include a cartridge that can be attached to or detached from the liquid ejection apparatus 100, a bag-shaped ink pack formed of a flexible film, and an ink tank that can be refilled with ink, or the like. Note that types of ink to be stored in the liquid container 10 are not specifically limited and optional.

The control unit 20 controls operations of each element of the liquid ejection apparatus 100. The control unit 20 includes, for example, a processing circuit such as a CPU (Central Processing Unit) or an FPGA (Field Programmable Gate Array), and a memory circuit such as a semiconductor memory, and controls operations of each element of the liquid ejection apparatus 100.

The transport unit 50 transports the medium M in a DM direction under the control of the control unit 20. The DM direction in the present embodiment is the X1 direction. In an example illustrated in FIG. 1, the transport unit 50 includes a transport roller that is elongated along the Y-axis and a motor that rotates the transport roller. Note that the transport unit 50 is not limited to a configuration that uses a transport roller, and may be configured to use a drum or an endless belt that transports the medium M adsorbed on an outer peripheral surface by electrostatic force, or the like.

Under the control of the control unit 20, the liquid ejection head 30 ejects ink supplied from the liquid container 10 from each of a plurality of nozzles N onto the medium M in the Z2 direction. The liquid ejection head 30 is a line head that is elongated in a direction in which the Y-axis extends. The liquid ejection head 30 includes a plurality of head chips 3 disposed such that the plurality of nozzles N is distributed over an entire range of the medium M in a direction along the Y-axis. Ink being ejected from the liquid ejection head 30 concurrently with transport of the medium M by the transport unit 50, an image is formed by ink on a surface of the medium M.

Note that the number and arrangement of the head chips 3 of the liquid ejection head 30 is not limited to the example illustrated in FIG. 1, and are optional. In addition, if the liquid ejection head 30 is configured to be capable of circulating ink, the liquid ejection head 30 may be connected to the liquid container 10 via a circulating mechanism for circulating ink in the liquid ejection head 30.

Such a liquid ejection apparatus 100 includes a liquid ejection head 30 that ejects ink onto a medium M and a transport unit 50 that transports the medium M. As will be described below, in the liquid ejection head 30, temperature differences in the liquid ejection head 30 are made uniform, thereby reducing a risk of occurrence of waring of the members that constitute the liquid ejection head 30. Therefore, according to the liquid ejection apparatus 100 including such a liquid ejection head 30, it is possible to suppress deterioration in print quality.

### 1-2. Overall Configuration of Head Chip 3

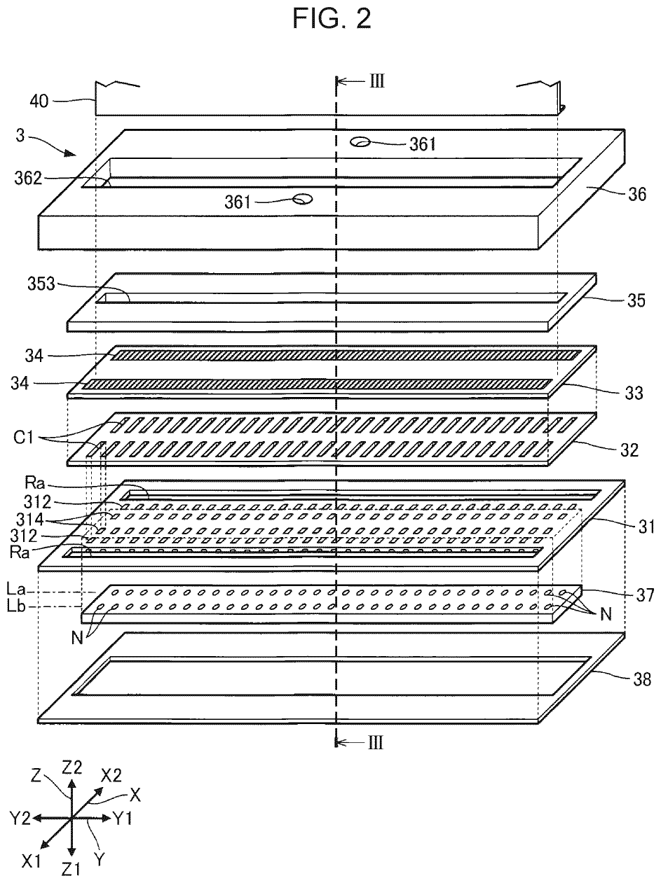

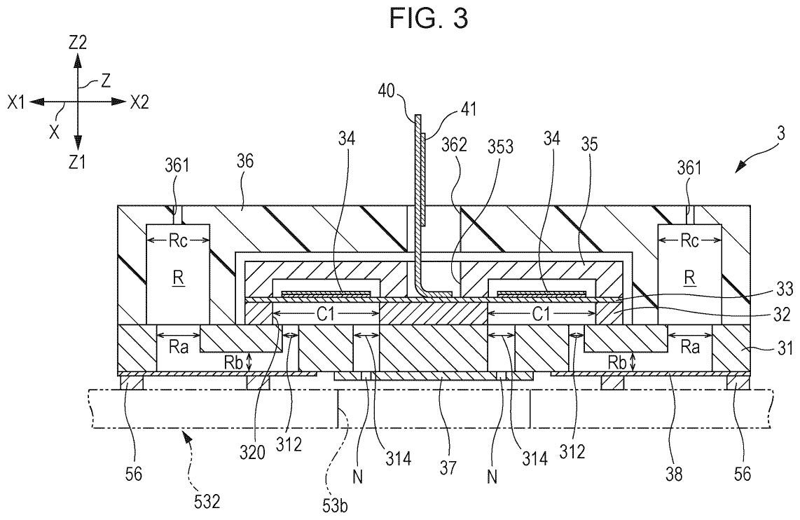

FIG. 2 is an exploded perspective view of the head chip 3 illustrated in FIG. 1. FIG. 3 is a cross-sectional view of a line III-III in FIG. 2. A cross section illustrated in FIG. 3 is a cross section parallel to an X-Z plane. The Z-axis is an axial line along an ink ejection direction by the liquid ejection head 30.

As illustrated in FIG. 2, the head chip 3 includes the plurality of nozzles N arranged along the Y-axis. The plurality of nozzles N is divided into a nozzle row La and a nozzle row Lb that are placed side by side with a space therebetween along the X-axis. Each of the nozzle row La and the nozzle row Lb is a collection of the plurality of nozzles N arranged linearly along the Y-axis. The liquid ejection head 30 is such configured that elements related to respective nozzles N of the nozzle row La and elements related to respective nozzles N of the nozzle row Lb are approximately plane-symmetrically disposed. In the following description, the elements corresponding to the nozzle row La will be mainly described, and a description of the elements corresponding to the nozzle row Lb will be omitted as appropriate. In addition, in the following, when a distinction is not made between the nozzle row La and the nozzle row Lb, they will be referred as the nozzle row L.

As illustrated in FIG. 2 and FIG. 3, the head chip 3 includes a communicating plate 31, a pressure chamber substrate 32, a vibration plate 33, a nozzle plate 37, a vibration absorber 38, a plurality of driving elements 34, a sealing substrate 35, a housing portion 36, and a wiring substrate 40.

Each of the communicating plate 31, the pressure chamber substrate 32, the vibration plate 33, the nozzle plate 37, and the vibration absorber 38 is an elongated plate-like member along the Y-axis. The pressure chamber substrate 32 and the housing portion 36 are installed on a surface of the communicating plate 31 in the Z2 direction. The nozzle plate 37 and the vibration absorber 38 are installed on a surface of the communicating plate 31 in the Z1 direction. For example, the respective members are fixed together by an adhesive, for example.

The nozzle plate 37 is a plate-like member on which the plurality of nozzles N is formed. Each of the plurality of nozzles N is a circular through-hole for ejecting ink. For example, the nozzle plate 37 is manufactured by processing a monocrystalline substrate of silicon (Si) utilizing semiconductor manufacturing techniques such as photolithography and etching, or the like.

A plurality of narrowing portions 312, a plurality of communicating flow channels 314, a communicating space Ra, and a common flow channel Rb are formed on the communicating plate 31. The narrowing portions 312 and the communicating flow channel 314 are each a through-hole extending in the Z1 direction and formed for each of the nozzles N. The communicating flow channel 314 overlaps with the nozzles N in a planar view. The communicating space Ra is an opening formed in an elongated shape along the Y-axis. The communicating space Ra extends along the Y-axis. The common flow channel Rb communicates to the communicating space Ra and overlaps with the communication space Ra in a planar view. The common flow channel Rb extends along the Y-axis. The common flow channel Rb communicates to the plurality of narrowing portions 312. In addition, the communicating space Ra causes the common flow channel Rb and an external flow channel of the head chip 3 to communicate with each other via a space Rc and a supply port 361 which are described below.

A plurality of pressure chambers C1 is formed in the pressure chamber substrate 32. The pressure chamber C1 is a space located between the communicating plate 31 and the vibration plate 33, and formed by a wall surface 320 of the pressure chamber substrate 32. The pressure chamber C1 is formed for each of the nozzles N. The pressure chamber C1 is an elongated space extending in the X1 direction. A plurality of the pressure chambers C1 is arranged along the Y-axis. The nozzle N communicates to one end of the pressure chamber C1 in the X1 direction, via the communicating flow channel 314. The narrowing portion 312 communicates to the other end of the pressure chamber C1 in the X1 direction. The narrowing portion 312 has a smaller cross-sectional area than the pressure chamber C1. In addition, the pressure chamber C1, the nozzle N, the communicating flow channel 314, and the narrowing portion 312 constitute an individual flow channel for each of the nozzles N.

The communicating plate 31 and the pressure chamber substrate 32 are manufactured by processing a semiconductor substrate such as a silicon monocrystalline substrate, for example.

The vibration plate 33 which is elastically deformable is disposed in the upper part of the pressure chamber C1. The vibration plate 33 is laminated on the pressure chamber substrate 32, and contacts a surface of the pressure chamber substrate 32 opposite to the communicating plate 31. The vibration plate 33 is a plate-like member formed in an elongated rectangular shape along the Y-axis in a planar view. A thickness direction of the vibration plate 33 is parallel to the Z1 direction. The pressure communicating chamber C1 communicates to the communicating flow channel 314 and the narrowing portion 312. Therefore, the pressure chamber C1 communicates to the nozzles N via the communicating flow channel 314, and communicates to the communicating space Ra via the narrowing portion 312. Note that, for ease of explanation, the pressure chamber substrate 32 and the vibration plate 33 are illustrated as separate substrates in FIG. 2, but in reality, they are laminated on a single silicon substrate.

A driving element 34 is formed for each pressure chamber C1 on a surface of the vibration plate 33 opposite to the pressure chamber C1. The driving element 34 is an elongated piezoelectric element along the X-axis in a planar view. The driving element 34 includes, for example, a pair of electrodes and a piezoelectric body sandwiched between the pair of electrodes. Note that the driving element 34 may be an electrothermal conversion element that generates thermal energy.

The housing portion 36 is a case for storing ink supplied to the plurality of pressure chambers C1, and is formed by, for example, injection molding of a resin material. The space Rc and the supply port 361 are formed in the housing portion 36. The supply port 361 is a conduit through which ink is supplied from the liquid container 10 and communicates to the space Rc. The space Rc in the housing portion 36 and the communicating space Ra of the communicating plate 31 communicate with each other. The communicating space Ra, the common flow channel Rb, and the space Rc described above constitute a common R common to the plurality of nozzles N. The common space R functions as a liquid storage chamber that stores ink to be supplied to the plurality of pressure chambers C1. The ink stored in the common space R branches off to each of the narrowing portions 312, and is supplied to and filled in parallel with the plurality of pressure chambers C1.

The vibration absorber 38 is a flexible film that constitutes the wall surface of the communicating space Ra, and absorbs pressure fluctuations of ink in the common space R. The vibration absorber 38 is, for example, a laminated body of an ink-resistant resin film, a SUS (stainless steel) member that holds the resin film and has spring properties, and a fixing plate that protects the resin film and the SUS member. Provision of the vibration absorber 38 stabilizes natural vibration frequency of the flow channel from the nozzles N through the pressure chambers C1 to the narrowing portion 312, irrespective of the nozzles N that are driven.

A frame body 56 is bonded to a surface facing the Z1 direction of the vibration absorber 38 with an adhesive, or the like. The frame body 56 is a frame-shaped member along an outer periphery of the vibration absorber 38. The frame body 56 includes, for example, a metal material. A fixing plate 532, to be described below, is bonded to the surface facing the Z1 direction of the frame body 56 with an adhesive, or the like, as depicted by a two-dot chain line in the figure.

The sealing substrate 35 is a structure body that protects a plurality of the driving elements 34 and reinforces mechanical strength of the pressure chamber substrate 32 and the vibration plate 33. The sealing substrate 35 is fixed to a surface of the vibration plate 33 with, for example, an adhesive, or the like. The plurality of driving elements 34 is housed inside a concave portion formed on a surface of the sealing substrate 35 opposed to the vibration plate 33. In addition, the wiring substrate 40 is inserted through a through-hole 362 of the housing portion 36 and the through-hole 353 of the sealing substrate 35. The wiring substrate 40 is bonded to the surface of the vibration plate 33. The wiring substrate 40 is a mounted component on which a plurality of wire lines for electrically connecting the control unit 20 with the head chip 3 is formed. The wiring substrate 40 includes a driving IC 41. The driving IC 41 is a circuit including a switching element that selects whether or not to supply a drive signal Com to the driving elements 34. For example, a TCP (Tape Carrier Package) or an FPC (flexible Printed Circuit), or the like is used, as the wiring substrate 40. A driving signal for driving the driving elements 34 and a reference voltage are supplied to the each of driving elements 34 from the wiring substrate 40. Although not illustrated, at least a part of the driving IC 41 is located inside an unillustrated through-hole, through which the wiring substrate 40 is inserted, the through hole being formed in a flow channel structure 52 and a frame portion 531.

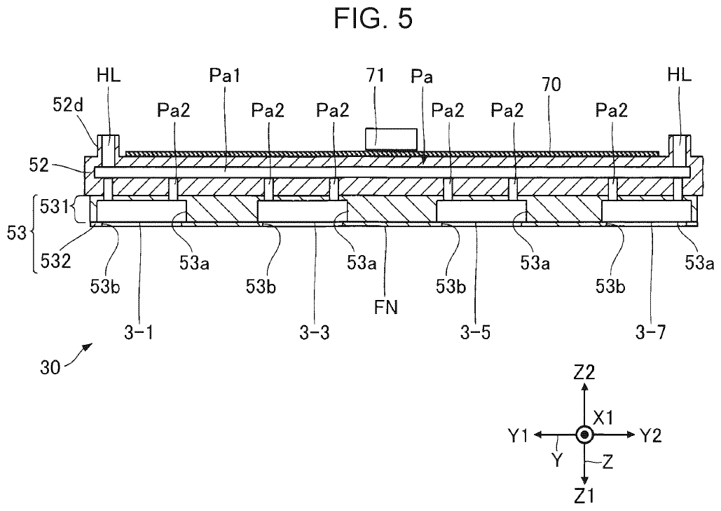

In addition, as illustrated in FIG. 5, the liquid ejection head 30 includes a relay substrate 70 that is elongated in the Y1 direction, and to which the plurality of wiring substrates 40 is electrically connected. A connector 71 is provided in this relay substrate 70, and the control unit 20 and the relay substrate 70 are electrically connected via the connector 71 by an unillustrated wiring member.

In such a head chip 3, when the driving elements 34 shrink due to current being carried, the vibration plate 33 is bent and deflected in a direction in which a volume of the pressure chamber C1 is reduced. Then, a pressure in the pressure chambers C1 increases, causing ink droplets to be ejected from the nozzles N. At this time, the pressure also propagates from the pressure chambers C1 toward the narrowing portion 312, and ink also flows into the common flow channel Rb through the narrowing portion 312. After the ink is ejected, the driving element 34 returns to its original position. At this time, the ink in the common flow channel Rb from the nozzle N also vibrates. Then, at the same time that the meniscus of the nozzle N returns to its original state, ink is supplied from the narrowing portion 312. With a series of the operations described above, ink is ejected from the nozzles N.

### 1-3. Liquid Ejection Head 30

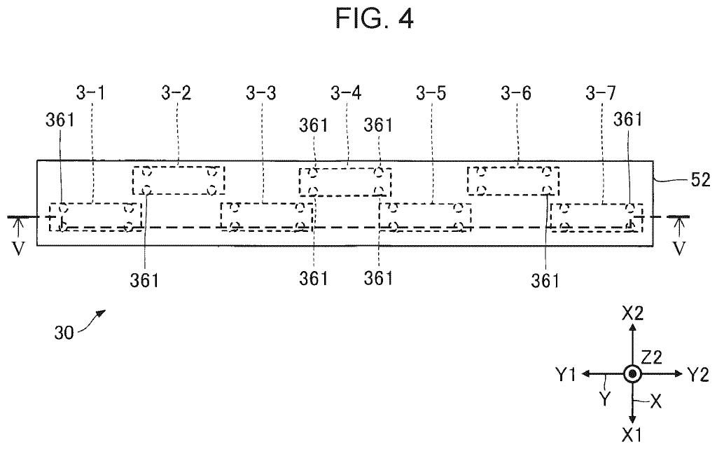

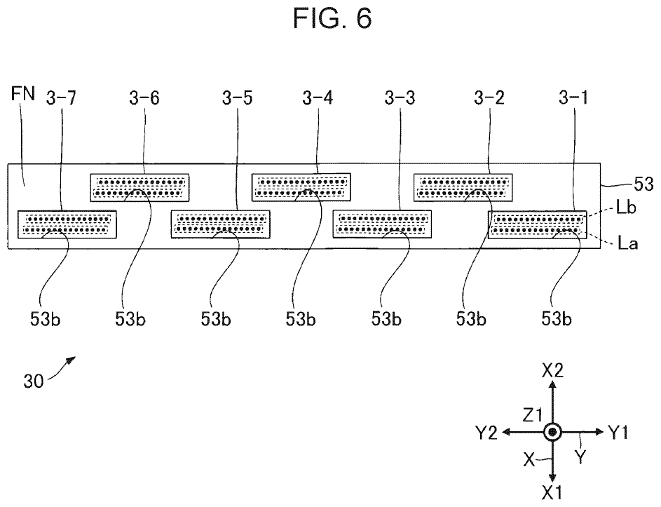

FIG. 4 is a top view of the liquid ejection head 30 of the first embodiment. FIG. 5 is a cross-sectional view taken along a line V-V in FIG. 4. FIG. 6 is a schematic diagram of a lower surface of the liquid ejection head 30 of the first embodiment. . . . In FIG. 4, FIG. 5, and FIG. 6, the liquid ejection head 30 having head chips 3-1 to 3-7 is schematically illustrated. The head chips 3-1 to 3-7 are each the head chips 3 described above. Hereinafter, each of the head chips 3-1 to 3-7 may be referred to as the head chip 3.

The liquid ejection head 30 includes the head chips 3-1 to 3-7, a flow channel structure 52, and a support member 53.

The head chips 3-1 to 3-7 are disposed in a staggered manner along the Y2 direction when viewed in a direction along the Z-axis. The head chips 3-1, 3-3, 3-5, and 3-7 are lined up in this order in the Y2 direction. The head chips 3-1, 3-3, 3-5, and 3-7 are disposed so that their positions are aligned with each other in the direction along the X-axis. In addition, the head chips 3-2, 3-4, and 3-6 are lined up in this order in the Y2 direction. The head chips 3-2, 3-4, and 3-6 are disposed further in the X2 direction than the head chips 3-1, 3-3, 3-5, and 3-7, and are aligned with each other in the direction along the X-axis.

The flow channel structure 52 is a structure within which a flow channel Pa is provided for supplying ink from the liquid container 10 to the plurality of head chips 3. The flow channel structure 52 includes, for example, a resin material or a metal material, or the like. A plurality of pipe sections 52d is provided in the flow channel structure 52. Each of the plurality of pipe sections 52d protrudes from the flow channel structure 52 toward the Z1 direction.

The flow channel Pa includes a common flow channel Pa1, a plurality of branching flow channels Pa2, and a plurality of openings HL. The common flow channels Pa1 and the plurality of branching flow channels Pa2 are formed in the flow channel structure 52. The plurality of openings HL is formed in a one-to-one correspondence with the plurality of pipe sections 52d.

The common flow channel Pa1 is a flow channel provided to be common to the plurality of head chips 3. Specifically, the common path Pa1 includes a flow channel provided in common to the head chips 3-1, 3-3, 3-5, and 3-7, and a flow channel provided in common to the head chips 3-2, 3-4, and 3-6. Each of these flow channels extend in the direction along the Y-axis, and both ends of each of the flow channels communicate to the opening HL facing in the Z2 direction. The ink from the liquid container 10 is introduced into the opening HL.

The plurality of branching flow channels Pa2 is provided for each of the supply ports 361 of the head chips 3-1 to 3-7. Each of the plurality of branching flow channels Pa2 communicates to the corresponding supply port 361.

The support member 53 is a member directly and commonly supporting the plurality of head chips 3. The support member 53 is disposed on a surface of the flow channel structure 52 facing the Z1 direction, and is connected to the flow channel structure 52. The support member 53 includes a frame portion 531 and a fixing plate 532.

The frame portion 531 has a plurality of concave portions 53a that houses the plurality of head chips 3. The plurality of concave portions 53a is a recess provided on a surface of the frame portion 531 facing the Z1 direction. Note that the plurality of concave portions 53a may be provided on each of the head chips 3 or may be provided for each group of two or more head chips 3. For example, the plurality of concave portions 53a is formed by dividing one concave portion into a plurality of sections.

The fixing plate 532 is disposed on the surface of the frame portion 531 facing the Z1 direction, and is connected to the frame portion 531. The fixing plate 532 is a plate-like member for fixing the plurality of head chips 3. The head chips 3 are housed in a housing space defined by the fixing plate 532 and the concave portions 53a of the frame portion 531.

A plurality of exposed openings 53b is provided on the fixing plate 532, the plurality of exposed openings 53b exposing the nozzle plate 37 of each of the head chips 3 to outside of the liquid ejection head 30. Each of the exposed openings 53b is a hole formed on the fixing plate 532. The plurality of exposed openings 53b is individually provided for each of the head chips 3. Each of the exposed openings 53b exposes a plurality of nozzles of the nozzle plate 37 of each of the head chips 3. The surface of the fixing plate 532 of the liquid ejection head 30 facing the Z1 direction constitutes an ejection surface FN together with the nozzle plate 37 exposed from the exposed opening 53b. As illustrated in FIG. 3, in the present embodiment, the exposed openings 53b are formed so as to overlap with the plurality of nozzles N of the nozzle plate 37. A part of the fixing plate 532 overlaps with an outer periphery of the nozzle plate 37 when viewed in the Z1 direction. Note that the exposed opening 53b may overlap with an entire region of the nozzle plate 37 in a planar view. That is, the entire nozzle plate 37 may be exposed from the exposed opening 53b.

Such a support member 53 includes, for example, a metal material such as stainless steel, titanium, and magnesium alloy, or a resin material. Note that the fixing plate 532 and the frame portion 531 include separate members, but may be integrally formed. In addition, a part of the support member 53 may be integrally formed with the flow channel structure 52. For example, the frame portion 531 may be integrally formed with the flow channel structure 52.

### 1-4. Overlapping Region of Head Chip 3

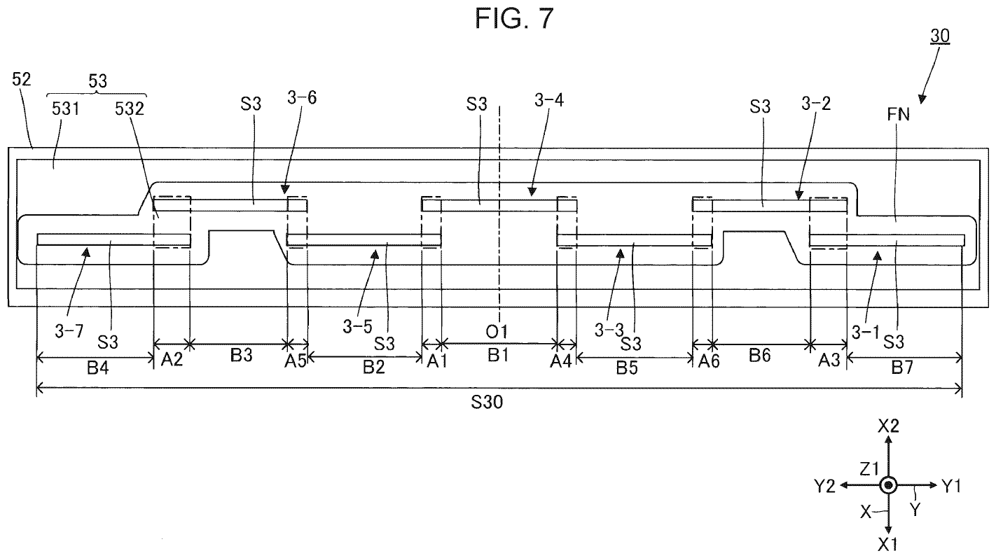

FIG. 7 is a bottom view of the liquid ejection head 30 of the first embodiment.

As illustrated in FIG. 7, the ejection surface FN of the liquid ejection head 30 includes a total nozzle forming region S30 including all nozzle forming regions S3 of the plurality of head chips 3. The nozzle forming region S3 is a region extending from the nozzle N disposed at one end in the Y1 direction to the nozzle N disposed on the other end, among the plurality of nozzles N formed in one head chip 3. FIG. 7 omits illustration of the nozzle N is omitted, and illustrates the nozzle forming regions S3. In addition, the total nozzle forming region S30 is a region, with respect to the Y1 direction, which extends from an end of the nozzle forming region S3 of the head chip 3-1 in the Y1 direction to an end of the nozzle forming region S3 of the head chip 3-7 in the Y2 direction. Further, in the present embodiment, a size of each of the nozzle forming regions S3 of the plurality of head chips 3, that is, a length in a direction along the Y-axis, is approximately the same as each other. Note that approximately the same size refers to a difference between two being 1% or less when the size of the nozzle forming region S3 of one head chip 3 is 100%.

As described above, the plurality of head chips 3 is disposed in a staggered manner along the Y1 direction, and five or more are provided. In the illustrated example, seven head chips 3 are provided. Then, the plurality of head chips 3 is disposed so as to have an overlapping region A where a part of the nozzle forming region S3 of one head chip 3 of adjacent head chips 3 and a part of the nozzle forming region S3 of the other head chip 3 overlap when viewed in the X1 direction. Thus, the overlapping region A exists between the adjacent head chips 3. Therefore, the plurality of head chips 3 includes a plurality of overlapping regions A. Note that the Y1 direction and the X1 direction are directions that are parallel to the nozzle forming regions S3 and perpendicular to the Z1 direction, which is the ink ejection direction.

The plurality of overlapping regions A includes a first overlapping region A1, a second overlapping region A2, a third overlapping region A3, a fourth overlapping region A4, a fifth overlapping region A5, and a sixth overlapping region A6.

The first overlapping region A1 is the overlapping region A where a part of the nozzle forming region S3 of the head chip 3-4 and a part of the nozzle forming region S3 of the head chip 3-5 overlap when viewed in the X1 direction. Among the plurality of overlapping regions A, the first overlapping region A1 is closest to a center position O1. The center position O1 is a center position of the total nozzle forming region S30 with respect to the Y1 direction.

The second overlapping region A2 is the overlapping region A where a part of the nozzle forming region S3 of the head chip 3-6 and a part of the nozzle forming region S3 of the head chip 3-7 overlap when viewed in the X1 direction. The second overlapping region A2 is farther away from the center position O1 than the first overlapping region A1. In the present embodiment, the second overlapping region A2 is provided in the Y2 direction with respect to the first overlapping region A1. In addition, the second overlapping region A2 is located furthest in the Y2 direction among the plurality of overlapping regions A, with respect to the Y1 direction. In addition, a size of the second overlapping region A2, that is, the length in the direction along the Y-axis, is larger than a size of the first overlapping region A1, that is, the length in the direction along the Y-axis.

The third overlapping region A3 is an overlapping region A where a part of the nozzle forming region S3 of the head chip 3-1 and a part of the nozzle forming region S3 of the head chip 3-2 overlap when viewed in the X1 direction. The third overlapping region A3 is farther away from the center position O1 than the first overlapping region A1. In the present embodiment, the third overlapping region A3 is provided in the Y1 direction relative to the first overlapping region A1. In addition, the third overlapping region A3 is located furthest in the Y1 direction among the plurality of overlapping regions A. In addition, a size of the third overlapping region A3, that is, the length in the direction along the Y-axis, is larger than the size of the first overlapping region A1. The size of the third overlapping region A3 is approximately the same as the size of the second overlapping region A2. Note that approximately the same size refers to a difference between the two being 1% or less when the size of the nozzle forming region S3 of one head chip 3 is 100%.

The fourth overlapping region A4 is the overlapping region A where a part of the nozzle forming region S3 of the head chip 3-4 and a part of the nozzle forming region S3 of the head chip 3-3 overlap when viewed in the X1 direction. The fourth overlapping region A4 is disposed so as to sandwich the center position O1 with the first overlapping region A1. In the present embodiment, a distance between the fourth overlapping region A4 and the center position O1 is approximately the same as a distance between the first overlapping region A1 and the center position O1. Thus, similarly to the first overlapping region A1, the fourth overlapping region A4 is the overlapping region A that closest to the center position O1 among the plurality of the overlapping regions A. In addition, a size of the fourth overlapping region A4, that is, the length in the direction along the Y-axis, is approximately the same as the size of the first overlapping region A1.

The fifth overlapping region A5 is an overlapping region A where a part of the nozzle forming region S3 of the head chip 3-5 and a part of the nozzle forming region S3 of the head chip 3-6 overlap when viewed in the X1 direction. The fifth overlapping region A5 is farther away from the center position O1 than the first overlapping region A1. In the present embodiment, the fifth overlapping region A5 is provided in the Y2 direction relative to the first overlapping region A1. The fifth overlapping region A5 is disposed between the first overlapping region A1 and the second overlapping region A2, with respect to the Y1 direction. In addition, a size of the fifth overlapping region A5, that is the length in the direction along the Y-axis, is approximately the same as the size of the first overlapping region A1.

The sixth overlapping region A6 is the overlapping region A where a part of the nozzle forming region S3 of the head chip 3-2 and a part of the nozzle forming region S3 of the head chip 3-3 overlap when viewed in the X1 direction. The sixth overlapping region A6 is farther away from the center position O1 than the fourth overlapping region A4. In the present embodiment, the sixth overlapping region A6 is provided in the Y1 direction relative to the fourth overlapping region A4. The sixth overlapping region A6 is disposed between the fourth overlapping region A4 and the third overlapping region A3, with respect to the Y1 direction. In addition, a size of the sixth overlapping region A6, the length in the direction along the Y-axis, is approximately the same as the size of the fourth overlapping region A4.

Note that the fourth overlapping region A4, the third overlapping region A3, and the sixth overlapping region A6 may be considered the first overlapping region A1, the second overlapping region A2, and the fifth overlapping region A5. In addition, the number of the head chips 3 only has to be 5 or larger, and may be equal to or larger than 6 or 8.

In addition, in each of the overlapping regions A, some nozzles N belonging to the nozzle forming region S3 of the one head chip 3 of the two adjacent head chips 3 and some nozzles N belonging to the nozzle forming region S3 of other head chip 3 overlap for each nozzle row L when viewed in the X1 direction.

In addition, each head chip 3 includes, among the nozzle forming regions S3, a non-overlapping region B that does not overlap, when viewed in the X1 direction, with the nozzle forming region S3 of the other head chip 3 of the adjacent head chip 3. The non-overlapping region B is a region different from the overlapping region A. The non-overlapping region B includes a plurality of non-overlapping regions B1, B2, B3, B4, B5, B6, and B7.

The non-overlapping region B1 is a region of the nozzle forming region S3 of the head chip 3-4 that is different from the first overlapping region A1 and the fourth overlapping region A4. The non-overlapping region B1 is a remaining region of the nozzle forming region S3 of the head chip 3-4, excluding the first overlapping region A1 and the fourth overlapping region A4. In the present embodiment, a size of the non-overlapping region B1, that is, the length in the direction along the Y-axis, is equal to or more than half the size of the nozzle forming region S3 of the head chip 3-4. The size of the non-overlapping region B1 is larger than the size of each of the first overlapping region A1 and the fourth overlapping region A4.

The non-overlapping region B2 is a region of the nozzle forming region S3 of the head chip 3-5 that is different from the first overlapping region A1 and the fifth overlapping region A5. The non-overlapping region B2 is a remaining region of the nozzle forming region S3 of the head chip 3-5, excluding the first overlapping region A1 and the fifth overlapping region A5. In the present embodiment, a size of the non-overlapping region B2, that is, the length in the direction along the Y-axis, is equal to or more than half the size of the nozzle forming region S3 of the head chip 3-5. The size of the non-overlapping region B2 is larger than the size of each of the first overlapping region A1 and the fifth overlapping region A5.

The non-overlapping region B3 is a region of the nozzle forming region S3 of the head chip 3-6 that is different from the second overlapping region A2 and the fifth overlapping region A5. The non-overlapping region B3 is a remaining region of the nozzle forming region S3 of the head chip 3-6, excluding the second overlapping region A2 and the fifth overlapping region A5. In the present embodiment, a size of the non-overlapping region B3, that is, the length in the direction along the Y-axis, is equal to or more than half the size of the nozzle forming region S3 of the head chip 3-6. The size of the non-overlapping region B3 is larger than the size of each of the second overlapping region A2 and the fifth overlapping region A5.

The non-overlapping region B4 is a region of the

nozzle forming region S3 of the head chip 3-7 that is different from the second overlapping region A2. The non-overlapping region B4 is a remaining region of the nozzle forming region S3 of the head chip 3-7, excluding the second overlapping region A2. In the present embodiment, a size of the non-overlapping region B4, that is, the length in the direction along the Y-axis, is equal to or more than half the size of the nozzle forming region S3 of the head chip 3-7. The size of the non-overlapping region B4 is larger than the size of the second overlapping region A2.

The non-overlapping region B5 is a region of the nozzle forming region S3 of the head chip 3-3 that is different from the fourth overlapping region A4 and the sixth overlapping region A6. The non-overlapping region B5 is a remaining region of the nozzle forming region S3 of the head chip 3-3, excluding the fourth overlapping region A4 and the sixth overlapping region A6. In the present embodiment, a size of the non-overlapping region B5, that is, the length in the direction along the Y-axis, is equal to or more than half the size of the nozzle forming region S3 of the head chip 3-3. The size of the non-overlapping region B5 is larger than the size of each of the fourth overlapping region A4 and the sixth overlapping region A6.

The non-overlapping region B6 is a region of the nozzle forming region S3 of the head chip 3-2 that is different from the third overlapping region A3 and the sixth overlapping region A6. The non-overlapping region B6 is a remaining region of the nozzle forming region S3 of the head chip 3-2, excluding the third overlapping region A3 and the sixth overlapping region A6. In the present embodiment, a size of the non-overlapping region B6, that is, the length in the direction along the Y-axis, is equal to or more than half the size of the nozzle forming region S3 of the head chip 3-2. The size of the non-overlapping region B6 is larger than the size of each of the third overlapping region A3 and the sixth overlapping region A6.

The non-overlapping region B7 is a region of the nozzle forming region S3 of the head chip 3-1 that is different from the third overlapping region A3. The non-overlapping region B7 is a remaining region of the nozzle forming region S3 of the head chip 3-1, excluding the third overlapping region A3. In the present embodiment, a size of the non-overlapping region B7, that is, the length in the direction along the Y-axis, is equal to or more than half the size of the nozzle forming region S3 of the head chip 3-1. The size of the non-overlapping region B7 is larger than the size of the third overlapping region A3.

As described above, the second overlapping region A2 is larger than the first overlapping region A1 with respect to the Y1 direction. When such a relationship is satisfied, it is possible to reduce the temperature difference in the total nozzle forming region S30, as compared to a case in which the relationship is not satisfied. Therefore, the influence of warping of the members constituting the liquid ejection head 30 can be mitigated.

As described above, each of the plurality of head chips 3 includes the wiring substrate 40 including the driving IC 41 connected to the driving element 34 for ejecting liquid. The driving IC 41 of the wiring substrate 40 is a heat source for the head chip 3.

The larger the size of the overlapping region A, that is, the length in the direction along the Y axis, the more likely it is that the heat will be high in the overlapping region A. That is, the larger the overlap amount of the overlapping region A, the more likely it is that the overlapping region A will become hot.

For example, the head chip 3-4, which is close to center position O1, is adjacent to the other four head chips 3-2, 3-3, 3-5, and 3-6. On the other hand, the head chips 3-1 and 3-7, which are closest to both ends of the total nozzle forming region S30 in the Y1 direction, are each just adjacent to two other head chips 3. The closer to center position O1 of the total nozzle forming region S30, the more difficult it is for heat from the head chip 3 to be dissipated, and the closer to both ends, the easier it is for heat from the head chip 3 to be dissipated.

Furthermore, the head chip 3 closer to the center position O1 generally requires a larger number of ink ejections from the nozzles N for image formation than the head chip 3 farther from the center position O1. That is, the driving IC 41 of the head chip 3 closer to the center position O1 is more likely to generate heat than the driving IC 41 of the head chip 3 farther from the center position O1.

Therefore, by making the second overlapping region A2 disposed on side of the head chip 3 a region that easily becomes hotter than the first overlapping region A1 and that has a large overlap amount, it is possible to make the temperature in the total nozzle forming regions S30 uniform. Therefore, it is possible to reduce the risk of the occurrence of warping of the members, which are elongated in the direction along the Y axis and which constitute the liquid ejection head 30, such as the frame portion 531 and the fixing plate 532. Therefore, it is possible to suppress the deterioration in print quality due to warping of the members of the liquid ejection head 30. Incidentally, if an attempt is made to thin the fixing plate 532 by shortening a distance between the medium M and the ejection surface FN to improve the print quality, the fixing plate may be formed of a metal to ensure rigidity. In addition, the frame portion 531 having a complex shape may be inexpensively formed from resin by injection molding. That is, when the fixing plate 532 is made of metal and the frame portion 531 is made of resin, a difference in the linear expansion coefficient between the two is large, making it easier for one to warp relative to the other. However, as in the present embodiment, the second overlapping region A2 disposed on the side of the head chip 3 where heat is more easily dissipated than the first overlapping region A1 being made a region that easily becomes hot and has a large overlap amount, the warping can be mitigated effectively.

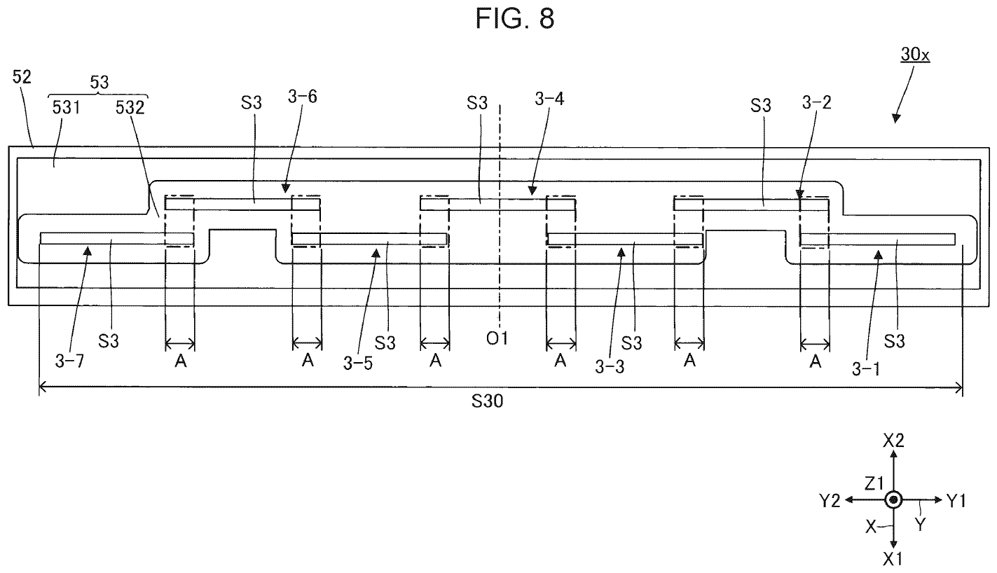

FIG. 8 is a bottom view of a liquid ejection head 30x of a comparative example. As illustrated in FIG. 8, in the existing liquid ejection head 30x, the sizes of the plurality of overlapping regions A are approximately the same as each other. In such a liquid ejection head 30x, the temperature near the center position O1 of the total nozzle forming region S30 rises more easily than the temperature at both ends. This warps the fixing plate 532, for example, resulting in a risk that the print quality may deteriorate.

In addition, in the present embodiment, as illustrated in FIG. 7, the second overlapping region A2 is the overlapping region A disposed at the end, with the Y1 direction, among the plurality of overlapping regions A. In this case, the second overlapping region A2 being larger than the first overlapping region A1, the effect of reducing the temperature difference in the total nozzle forming region S30 is produced prominently.

The first overlapping region A1 is the overlapping region A that is closest to the center position O1 among the plurality of overlapping regions A, with respect to the Y1 direction. In this case, the second overlapping region A2 being larger than the first overlapping region A1, the effect of reducing the temperature difference in the total nozzle forming region S30 is produced prominently.

In particular, in the present embodiment, the second overlapping region A2 is the overlapping region A that is disposed at the end of the plurality of overlapping regions A, with respect to the Y1 direction, and the first overlapping region A1 is the overlapping region A that is closest to the center position O1 among the plurality of overlapping regions A, with respect to the Y1 direction. The first overlapping region A1 and the second overlapping region A2 being disposed as described above, the effect of reducing the temperature difference in the total nozzle forming region S30 is produced prominently, in particular.

In addition, with respect to the Y1 direction, the size of the second overlapping region A2, that is, the length in a direction among the Y-axis, may be equal to or more than twice the average size of the plurality of overlapping regions A, that is, the length in the direction along the Y-axis. When the size of the second overlapping region A2 is less than twice the average size of the plurality of overlapping regions A, the effect of reducing the temperature difference in the total nozzle forming region S30 becomes weaker than a case in which the size of the second overlapping region A2 is equal to or more than twice the average size of the plurality of overlapping regions A.

From another perspective, the number of nozzles belonging to the second overlapping region A2 may be equal to or more than twice the average number of nozzles belonging to the plurality of overlapping regions A. For example, a case is considered in which the number of nozzles in each of the first overlapping region A1, the fourth overlapping region A4, the fifth overlapping region A5, and the sixth overlapping region A6 is 9, and in which the number of nozzles in each of the second overlapping region A2, and the third overlapping region A3 is 64. In this case, an average number of nozzles belonging to the plurality of overlapping regions A is approximately 27. Therefore, twice the average is approximately 54. The number of nozzles belonging to the second overlapping region A2 being equal to or more than twice the average number of nozzles, it is possible to make the second overlapping region A2 disposed on the side of the head chip 3 where heat is more easily dissipated a region that easily becomes hot and has the large overlap amount, as compared to a case in which the number of nozzles is less than twice the average number of nozzles. Therefore, it becomes easier to reduce the temperature difference in the total nozzle forming region S30.

Note that the size of the second overlapping region A2 may be less than twice the average size of the plurality of overlapping regions A. In addition, the number of nozzles belonging to the second overlapping region A2 may be less than twice the average number of nozzles belonging to the plurality of overlapping regions A.

With respect to the Y1 direction, the size of the first overlapping region A1 may be equal to or less than ½ the average size of the plurality of overlapping regions A. The size of the first overlapping region A1 being equal to or less than ½ the average size of the plurality of overlapping region s A, elongation as a line head becomes easier than when the size of the first overlapping region A1 exceeds ½.

From another perspective, the number of nozzles belonging to the first overlapping region A1 may be equal to or less than 2/1 the average number of nozzles belonging to the plurality of overlapping regions A. For example, a case is considered in which the number of nozzles in each of the first overlapping region A1, the fourth overlapping region A4, the fifth overlapping region A5, and the sixth overlapping region A6 is 9, and in which the number of nozzles in each of the second overlapping region A2, and the third overlapping region A3 is 64. In this case, an average number of nozzles belonging to the plurality of overlapping regions A is approximately 27. Therefore, ½ the average is approximately 14. If the number of nozzles belonging to the first overlapping region A1 is equal to or less than ½ the average number of nozzles belonging to the plurality of overlapping regions A, elongation as a line head becomes easier than when the size of the first overlapping region A1 exceeds ½.

In particular, with respect to the Y1 direction, the size of the second overlapping region A2 may be equal to or more than twice the average size of the plurality of overlapping regions A, and with respect to the Y1 direction, the size of the first overlapping region A1 may be equal to or less than ½ the average size of the plurality of overlapping regions A. When such a relationship is satisfied, the effect of the second overlapping region A2 being the first overlapping region A1 is more likely to be achieved, as compared to a case in which the relationship is not satisfied. Therefore, it is possible to make uniform the temperature in the total nozzle forming region S30 and to suppress the occurrence of waring of the members of the liquid ejection head 30. In addition, the liquid ejection head 30 can be suitably used as a line head.

Note that the size of the first overlapping region A1 may exceed ½ the average size of the plurality of overlapping regions A. In addition, the number of nozzles belonging to the first overlapping region A1 may exceeds ½ the average number of nozzles belonging to the plurality of overlapping regions A.

With respect to the Y1 direction, the size of the second overlapping region A2 may be 5 times or more the size of the first overlapping region A1. If the size of the second overlapping region A2 is 5 times or more the size of the first overlapping region A1, it is possible to suitably reduce the temperature difference between the vicinity of the center position O1 and the vicinity of the end of the total nozzle forming region S30, as compared to a case in which the size of the first overlapping region A1 is less than 5 times. This makes it possible to suppress the occurrence of warping of the members of the liquid ejection head 30 due to a part of the total nozzle forming region S30 becoming hot. The size of the second overlapping region A2 may be 7 times or more the size of the first overlapping region A1. Note that the size of the second overlapping region A2 may be less than 5 times the size of the first overlapping region A1.

In addition, the plurality of overlapping regions A includes the third overlapping region A3, in addition to the second overlapping region A2. Then, with respect to the Y1 direction, the size of the second overlapping region A2 is approximately the same as the size of the third overlapping region A3. Provision of such a third overlapping region A3 allows the amount of heat generated at both ends of the total nozzle forming region S30 to be uniformly distributed.

Note that approximately the same size refers to a difference between the two being 18 or less when the size of the nozzle forming region of one head chip in the first direction is 100%. For example, approximately the same size indicates that the difference is 4 nozzles or less, which is 1% of the number of nozzles, when the number of nozzles included in the nozzle forming region S3 of one head chip 3 in the first direction is 400.

In addition, the plurality of overlapping regions A includes the fourth overlapping region A4. With respect to the Y1 direction, the size of the fourth overlapping region A4 is approximately the same as the size of the first overlapping region A1. Provision of such a fourth overlapping region A4 makes uniform the temperature distribution on both sides of the center position O1 in the vicinity of the center position O1. Therefore, heat bias near the center position O1 in the total nozzle forming region S30 is reduced.

With respect to the Y1 direction, a total size of the plurality of overlapping regions A is smaller than the size of the nozzle forming region S3 of the one head chip 3. The total size being smaller than the size of the nozzle forming region S3 makes it possible to avoid excessively increasing the number of nozzles included in the overlapping regions A and to suitably use the liquid ejection head 30 as a line head, as compared to a case in which the total size is larger than the size of the nozzle forming region S3. Note that the total size may be larger than the size of the one nozzle forming region S3.

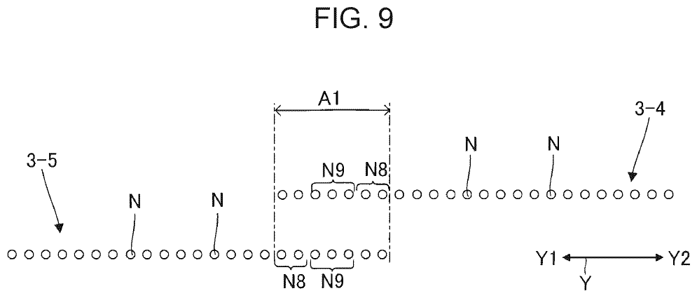

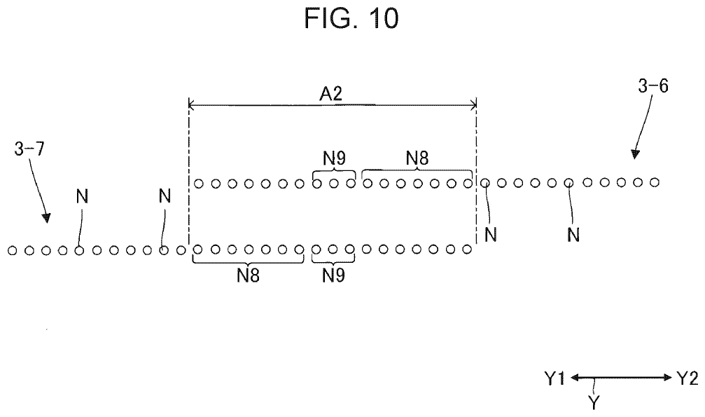

FIG. 9 is a diagram illustrating the number of overlapping nozzles that eject ink droplets in the first overlapping region A1. FIG. 10 is diagram illustrating the number of overlapping nozzles that eject ink droplets in the second overlapping region A2. Note that FIG. 9 and FIG. 10 illustrate the nozzle row La of each of the head chips 3 as a representative.

The number of nozzles in the first overlapping region A1 is different from that in the second overlapping region A2. However, the number of overlapping nozzles used to eject ink droplets may be set to be equal.

In the example illustrated in FIG. 9, seven nozzles of the nozzle row La of the head chip 3-4 belong to the first overlapping region A1, and seven nozzles of the nozzle row La of the head chip 3-5 belong to the first overlapping region A1. Of the seven nozzles N, three nozzles N9 and two nozzles N8 are nozzles N used to eject ink droplets. In the first overlapping region A1, the three nozzles N9 of the head chip 3-4 overlap with the three nozzles N9 of the head chip 3-5 when viewed in the X1 direction.

Therefore, the number of nozzles belonging to the first overlapping region A1 is seven in one nozzle row La. In contrast, in the first overlapping region A1, the number of overlapping nozzles used to eject ink droplets is three in the one nozzle row La.

In the example illustrated in FIG. 10, seventeen nozzles of the nozzle row La of the head chip 3-6 belong to the second overlapping region A2, and seventeen nozzles of the nozzle row La of the head chip 3-7 belong to the second overlapping region A2. Of the seventeen nozzles N, three nozzles N9 and seven nozzles N8 are nozzles N used to eject ink droplets. In the second overlapping region A2, the three nozzles N9 of the head chip 3-6 overlap with the three nozzles N9 of the head chip 3-7 when viewed in the X1 direction.

Therefore, the number of nozzles belonging to the second overlapping region A2 is seventeen in one nozzle row La. In contrast, in the second overlapping region A2, the number of overlapping nozzles used to eject ink droplets is three in the one nozzle row La.

In the first overlapping region A1 and the second overlapping region A2, the number of overlapping nozzles used to eject ink droplets is the same as each other. By making the number of overlapping nozzles equal in the respective overlapping regions A, it is possible to reduce a difference in overlapping ink droplets that land among the head chips 3, even when the second overlapping region A2 is made larger than the first overlapping region A1 with respect to the Y1 direction.

### 2. Modification Examples

Each of the exemplary embodiments described above

may be modified in various manners. Specific modified embodiments that may be applied to each of the above-described embodiments will be exemplified below. Two or more aspects that are optionally selected from the following examples may be combined appropriately to the extent that they do not conflict with each other.

### 2-1. First Modification Example

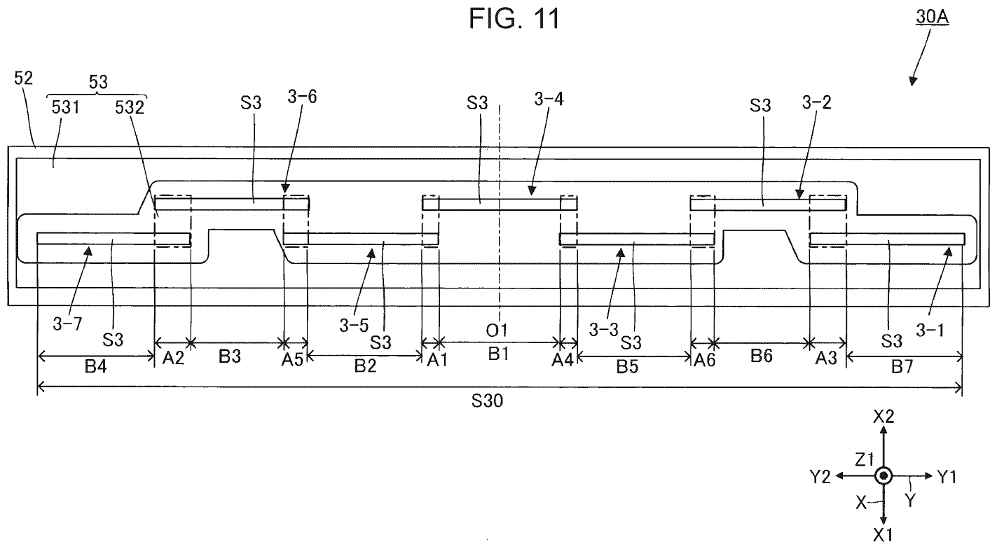

FIG. 11 is a bottom view of a liquid ejection head 30A of a first modification example. In the liquid ejection head 30A of the first modification example illustrated in FIG. 11, with respect to the Y1 direction, the size of the fifth overlapping region A5 is larger than a size of the first overlapping region A1, and is smaller than the second overlapping region A2. That is, the size of each of the first overlapping region A1, the fifth overlapping region A5, and the second overlapping region A2 increases in this order. Therefore, the size of the overlapping region A increases stepwise toward the end of the total nozzle forming region S30 with respect to the Y1 direction. According to such a modification example, the part belonging to the overlapping region A of the head chip 3 that easily becomes hot is stepwise dispersed as compared to the embodiments described above. Therefore, the heat bias in the total nozzle forming region S30 can be further reduced. Note that with respect to the third overlapping region A3, the fourth overlapping region A4, and the sixth overlapping region A6, similarly, with respect to the Y1 direction, the sixth overlapping region A6 is smaller than the third overlapping region A3 and is larger than the fourth overlapping region A4.

### 2-2. Second Modification Example

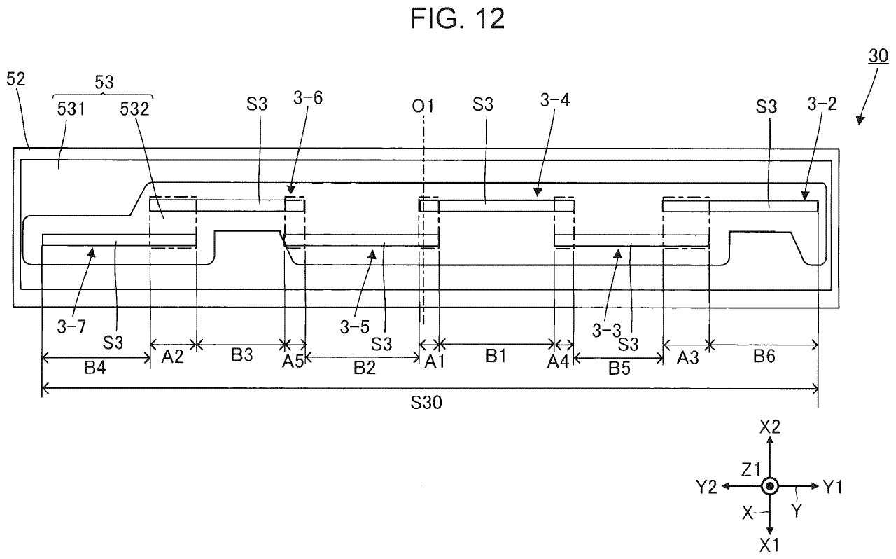

FIG. 12 is a bottom view of a liquid ejection head 30B of a second modification example. The liquid ejection head 30B of the second modification example illustrated in FIG. 12 includes six head chips 3. The number of head chips 3 of the liquid ejection head 30B is an even number. Note that in the example of FIG. 12, the head chip 3-1 is omitted. In the example of FIG. 12, the third overlapping region A3 is the overlapping region A where a part of the nozzle forming region S3 of the head chip 3-2 and a part of the nozzle forming region S3 of the head chip 3-3 overlap when viewed in the X1 direction. In addition, the center position O1 is located within the first overlapping region A1 with respect to the Y1 direction. Such a modification example also can reduce the heat bias in the total nozzle forming region S30.

### 2-3. Other Modification Examples

The head chip 3 does not have a structure for circulating ink, but the head chip 3 may be a circulation type head with a so-called circulating flow channel.

A “liquid ejection apparatus” may be applied to various devices such as a facsimile machines or copy machines, in addition to devices dedicated to printing. Uses of the liquid ejection apparatus are not limited to printing. For example, a liquid ejection apparatus that ejects a solution of a coloring material is used as a manufacturing apparatus for forming a color filter for a display device such as a liquid crystal display panel. In addition, a liquid ejection apparatus that ejects a solution of a conductive material is used as a manufacturing apparatus for forming wiring or electrodes for a wiring substrate. In addition, a liquid ejection apparatus for ejecting a solution of an organic substance related to a living body is used as a manufacturing apparatus for manufacturing biochips, for example.

Although the present disclosure has been described based on the preferred embodiments, the present disclosure is not limited to the above-described embodiments. In addition, the configuration of each part of the present disclosure can be replaced with any configuration that exhibits similar functions as the embodiments described above, and to which any configuration can be added.

What is claimed is:

1. A liquid ejection head comprising:
five or more head chips disposed along a first direction in a staggered manner, and
a support member supporting the head chips, wherein
the head chips is disposed to have overlapping regions where a part of a nozzle forming region of one head chip of adjacent head chips and a part of a nozzle forming region of other head chip overlap when viewed in a second direction that is perpendicular to the first direction,
the overlapping regions include a first overlapping region, and a second overlapping region that is farther away from a center position of a total nozzle forming region with respect to the first direction than the first overlapping region, the total nozzle forming region including all the nozzle forming regions of the head chips, and
the second overlapping region is larger than the first overlapping region with respect to the first direction.

2. The liquid ejection head according to claim 1, wherein:
the second overlapping region is an overlapping region that is disposed at the end among the overlapping regions, with respect to the first direction.

3. The liquid ejection head according to claim 1, wherein
the first overlapping region is an overlapping region that is closest to the center position, among the overlapping regions, with respect to the first direction.

4. The liquid ejection head according to claim 1, wherein
the first overlapping region is an overlapping region that is closest to the center position, among the overlapping regions, with respect to the first direction,
the second overlapping region is an overlapping region that is disposed at the end among the overlapping regions, with respect to the first direction.

5. The liquid ejection head according to claim 1, wherein:
a size of the second overlapping region is equal to or more than twice an average size of the overlapping regions, with respect to the first direction.

6. The liquid ejection head according to claim 1, wherein
a size of the first overlapping region is equal to or less than ½ the average size of the overlapping regions, with respect to the first direction.

7. The liquid ejection head according to claim 1, wherein
the size of the second overlapping region is equal to or more than twice the average size of the overlapping regions, with respect to the first direction,
the size of the first overlapping region is equal to or less than ½ the average size of the overlapping regions, with respect to the first direction.

8. The liquid ejection head according to claim 1, wherein
the size of the second overlapping region is 5 times or more the size of the first overlapping region, with respect to the first direction.

9. The liquid ejection head according to claim 1, wherein
each of the head chips includes a driving IC connected to a driving element for ejecting liquid.

10. The liquid ejection head according to claim 2, wherein
the overlapping regions includes a third overlapping region that is different from the second overlapping region,
the third overlapping region is an overlapping region that is disposed at the end among the overlapping regions, with respect to the first direction,
the size of the second overlapping region is approximately the same as that of the third overlapping region, with respect to the first direction.

11. The liquid ejection head according to claim 3, wherein
the overlapping regions includes a fourth overlapping region that is different from the first overlapping region,
the fourth overlapping region is an overlapping region other than overlapping regions disposed at both ends among the overlapping regions, with respect to the first direction, and
a size of the fourth overlapping region is approximately the same as that of the first overlapping region, with respect to the first direction.

12. The liquid ejection head according to claim 1, wherein
the overlapping regions includes a fifth overlapping region disposed between the first overlapping region and the second overlapping region, with respect to the first direction, and
a size of the fifth overlapping region is larger than a size of the first overlapping region and smaller than a size of the second overlapping region, with respect to the first direction.

13. The liquid ejection head according to claim 1, wherein
a total size of the overlapping regions is smaller than a size of the nozzle forming region of the head chip, with respect to the first direction.

14. A liquid ejection apparatus comprising:
a liquid ejection head according to claim 1, the liquid ejection head ejecting liquid onto a medium; and
a transport unit that transports the medium.
